(19) United States
(12) Patent Application Publication
(10) Pub. No.: US 2012/0000490 A1
(43) Pub. Date: Jan. 5, 2012

(54) METHODS FOR ENHANCED PROCESSING CHAMBER CLEANING

(75) Inventors: HUA CHUNG, San Jose, CA (US); Sang Won Kang, San Jose, CA (US)

(73) Assignee: APPLIED MATERIALS, INC., Santa Clara, CA (US)

(21) Appl. No.: 13/175,170

(22) Filed: Jul. 1, 2011

Related U.S. Application Data
(60) Provisional application No. 61/360,794, filed on Jul. 1, 2010.

(51) Int. Cl. B08B 9/00

(52) U.S. Cl. 134/22.12

(57) ABSTRACT

Methods and apparatus for cleaning a showerhead and other chamber components used in a chemical vapor deposition process are provided. The methods comprise establishing a thermal gradient in a chamber having a showerhead assembly with deposited material thereon, providing a halogen containing cleaning gas to the chamber, wherein the thermal gradient causes a turbulent or convective flow of the cleaning gas, removing the coating of deposited material from the showerhead assembly by reacting the halogen containing cleaning gas with the deposited material, and exhausting reaction by-products from the chamber.

### CROSS-REFERENCE TO RELATED APPLICATIONS

This application claims benefit of U.S. Provisional Patent Application Ser. No. 61/360,794 (Attorney Docket No. 15496L), filed Jul. 1, 2010, which is herein incorporated by reference in its entirety.

### BACKGROUND

1. Field

Embodiments of the present invention generally relate to methods and apparatus for cleaning a showerhead used in a chemical vapor deposition process.

2. Description of the Related Art

Group III-V films are finding greater importance in the development and fabrication of a variety of semiconductor devices, such as short wavelength light emitting diodes (LEDs), laser diodes (LDs), and electronic devices including high power, high frequency, high temperature transistors and integrated circuits. For example, short wavelength (e.g., blue/green to ultraviolet) LEDs are fabricated using the Group III-nitride semiconducting material gallium nitride (GaN). It has been observed that short wavelength LEDs fabricated using GaN can provide significantly greater efficiencies and longer operating lifetimes than short wavelength LEDs fabricated using non-nitride semiconducting materials, such as Group II-VI materials.

One method that has been used for depositing Group III-nitrides, such as GaN, is metal organic chemical vapor deposition (MOCVD). This chemical vapor deposition method is generally performed in a reactor having a temperature controlled environment to assure the stability of a first precursor gas which contains at least one element from Group III, such as gallium (Ga). A second precursor gas, such as ammonia (NH₃), provides the nitrogen needed to form a Group III-nitride. The two precursor gases are injected into a processing zone within the reactor where they mix and move towards a heated substrate in the processing zone. A carrier gas may be used to assist in the transport of the precursor gases towards the substrate. The precursors react at the surface of the heated substrate to form a Group III-nitride layer, such as GaN, on the substrate surface.

Interaction of the precursor gases with the hot hardware components, which are often found in the processing zone of an LED or LD forming reactor, generally causes the precursor to break-down and deposit on these hot surfaces. Typically, the hot reactor surfaces are formed by radiation from the heat sources used to heat the substrates. The deposition of the precursor materials on the hot surfaces can be especially problematic when it occurs in or on the precursor distribution components, such as the showerhead. Deposition on the precursor distribution components affects the flow distribution uniformity over time, which may have a negative impact on the quality of processed substrates. Therefore, there is a need for a method and apparatus for cleaning or removing the deposited precursor material from chamber components, such as a showerhead.

### SUMMARY

Embodiments of the present invention generally relate to methods and apparatus for cleaning a showerhead used in a chemical vapor deposition process. In one embodiment, a method of cleaning a showerhead assembly is provided. The method comprises establishing a thermal gradient in a processing region of a chamber having a showerhead assembly with deposited material thereon, providing a halogen containing cleaning gas to the processing region, wherein the thermal gradient causes a turbulent or convective flow of the cleaning gas, removing the deposited material from the showerhead assembly, and exhausting reaction by-products from the processing region.

In yet another embodiment, a method of removing deposited material from one or more interior surfaces of a processing chamber is provided. The method comprises establishing a thermal gradient in a processing region of a chamber, wherein the processing region is defined by a showerhead assembly with deposited material thereon and an opposing substrate support having a cleaning plate positioned thereon, providing a halogen containing cleaning gas to the processing region, wherein the thermal gradient causes a turbulent or convective flow of the cleaning gas, removing deposited material from the showerhead assembly, and exhausting reaction by-products from the processing region.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic plan view illustrating one embodiment of a processing system for fabricating compound nitride semiconductor devices.

FIGS. 2A and 2B are schematic cross-sectional views of embodiments of metal-organic chemical vapor deposition (MOCVD) chambers;

FIG. 3 is an enlarged schematic cross-sectional view of one embodiment a showerhead assembly and substrate support;

FIG. 4 is a flow diagram summarizing a method for removing unwanted deposits from internal surfaces of a chamber according to one embodiment; and

FIG. 5 is a flow diagram summarizing another method for removing unwanted deposits from internal surfaces of a chamber according to one embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present invention generally relate to methods and apparatus for cleaning a showerhead used in a chemical vapor deposition process.

Exemplary showerheads that may be adapted to practice embodiments described herein are described in commonly assigned U.S. patent application Ser. No. 11/873,132, filed Oct. 16, 2007, now published as US 2009-0098276, entitled MULTI-GAS STRAIGHT CHANNEL SHOWERHEAD, commonly assigned U.S. patent application Ser. No. 11/873,141, filed Oct. 16, 2007, now published as US 2009-0095222, entitled MULTI-GAS SPIRAL CHANNEL SHOWERHEAD, and commonly assigned U.S. patent application Ser. No. 11/873,170, filed Oct. 16, 2007, now published as US 2009-0095221, entitled MULTI-GAS CONCENTRIC INJECTION SHOWERHEAD, all of which are incorporated by reference in their entireties. Other aspects of the MOCVD chamber 102 are described in commonly assigned U.S. patent application Ser. No. 12/023,520, filed Jan. 31, 2008, published as US 2009-0194024, and titled CVD APPARATUS, which is herein incorporated by reference in its entirety.

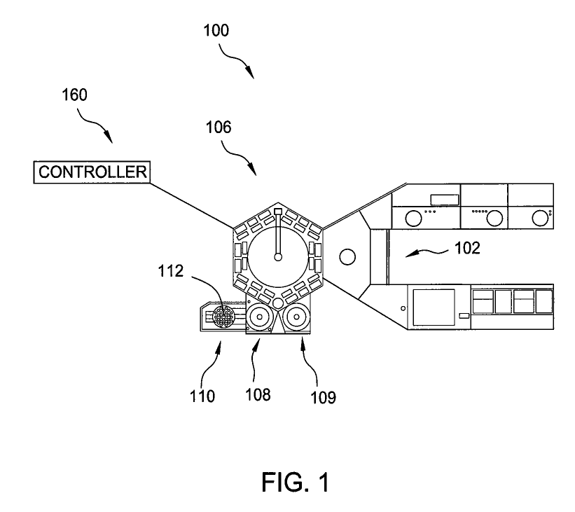

FIG. 1 is a schematic plan view illustrating one embodiment of a processing system 100 that comprises one or more MOCVD chambers 102 for fabricating compound nitride semiconductor devices. The processing system 100 is closed to atmosphere and comprises a transfer chamber 106, a MOCVD chamber 102 coupled with the transfer chamber 106, and a loadlock chamber 108 coupled with the transfer chamber 106. A batch loadlock chamber 109, capable of storing substrates, is coupled with the transfer chamber 106, and a load station 110, capable of loading substrates, is coupled with the loadlock chamber 108. The transfer chamber 106 comprises a robot assembly (not shown) operable to pick up and transfer substrates between the loadlock chamber 108, the batch loadlock chamber 109, and the MOCVD chamber 102. Although a single MOCVD chamber 102 is shown, more than one MOCVD chamber may be coupled with the transfer chamber 106. Additionally, one or more Hydride Vapor Phase Epitaxial (HVPE) chambers may also be coupled with the transfer chamber 106. It should also be understood that although a cluster tool is shown, the embodiments described herein are equally applicable to linear track systems. In one embodiment, the transfer chamber 106 remains under vacuum during substrate transfer processes to control the amount of contaminants, such as oxygen (O₂) or water (H₂O), to which the substrates are exposed.

In the processing system 100, the robot assembly (not shown) transfers a substrate carrier plate 112 loaded with substrates into the MOCVD chamber 102 to undergo deposition. The substrate carrier plate 112 generally has a diameter ranging from about 200 millimeters to about 750 millimeters, and may have a surface area of about 1,000 square centimeters or more, preferably 2,000 square centimeters or more, and more preferably 4,000 square centimeters or more. For example, the substrate carrier plate 112 may have a diameter of about 400 millimeters, and surface area of about 1256 square centimeters. The substrate carrier plate 112 may be formed from a variety of materials, including SiC, SiC-coated graphite, quartz, or sapphire. In one example, the substrate carrier plate 112 is configured to support between about 1 and about 50 substrates during processing.

After a desired number of deposition steps have been completed in the MOCVD chamber 102, the substrate carrier plate 112 is transferred from the MOCVD chamber 102 back to the loadlock chamber 108 via the transfer robot. The substrate carrier plate 112 can then be transferred to the load station 110, or stored in either the loadlock chamber 108 or the batch load lock chamber 109 prior to additional processing steps. One exemplary processing system 100 that may be adapted in accordance with embodiments of the present invention is described in commonly assigned U.S. patent application Ser. No. 12/023,572, filed Jan. 31, 2008, now published as US 2009-0194026, entitled PROCESSING SYSTEM FOR FABRICATING COMPOUND NITRIDE SEMICONDUCTOR DEVICES, which is hereby incorporated by reference in its entirety.

A system controller 160 controls activities and operating parameters of the processing system 100. The system controller 160 includes a computer processor and a computer-readable memory coupled to the processor. The processor executes system control software, such as a computer program stored in memory. Exemplary aspects of the processing system 100 and methods of use adaptable to embodiments of the present invention are further described in commonly assigned U.S. patent application Ser. No. 11/404,516, filed Apr. 14, 2006, now published as US 2007-024516, entitled EPITAXIAL GROWTH OF COMPOUND NITRIDE STRUCTURES, which is hereby incorporated by reference in its entirety.

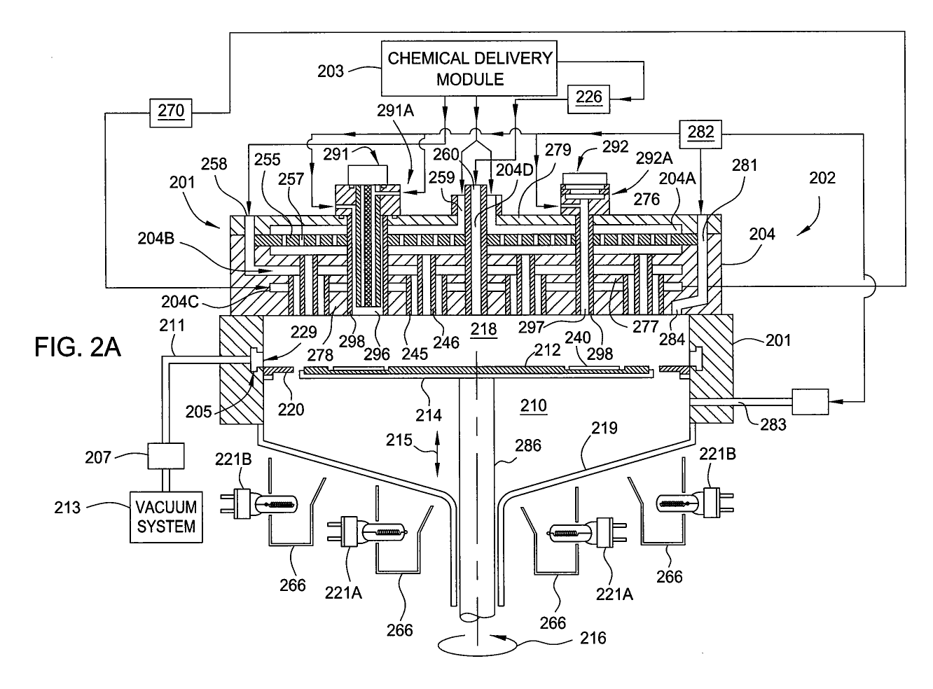

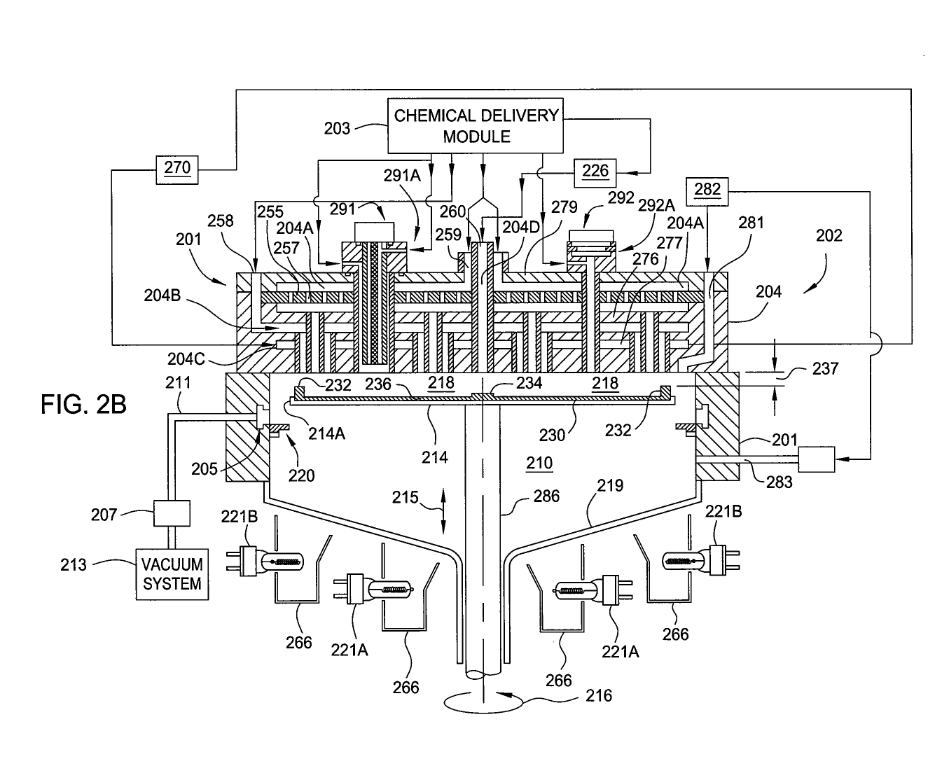

FIG. 2 is a schematic cross-sectional view of a metal-organic chemical vapor deposition (MOCVD) chamber configured to perform the chamber cleaning embodiments described herein. The MOCVD chamber 202 has a chamber body 201 and showerhead assembly 204 coupled thereto. A chemical delivery module 203 is coupled to the showerhead assembly 204 for delivering precursor gases, carrier gases, cleaning gases, and/or purge gases to the processing region 218. A substrate support 214 is disposed in an internal region of the processing chamber opposite the showerhead assembly 204 and between the processing region 218 and the lower volume 210. The vacuum system 213 is coupled to the processing region 218 to remove gases therefrom. A substrate carrier plate 212 may be disposed on the substrate support 214. In one embodiment, an actuator assembly 286 is capable of moving the substrate support 214 in a vertical direction towards or away from the showerhead assembly 204, as shown by arrow 215. In one embodiment, the actuator assembly 286 is also capable of rotating the substrate support 214, as shown by arrow 216. During a deposition process, the substrate support 214 is generally positioned about 4 mm to about 41 mm from a bottom surface of the showerhead assembly 204. The substrate support 214 may also comprise a heating element (not shown) for controlling the temperature of the substrate support 214 and the substrate carrier plate 212 disposed thereon.

A lower dome 219 is disposed at one end of a lower volume 210, and the substrate support 214 is disposed at the other end of the lower volume 210. The substrate carrier plate 212 is shown in an elevated, process position, but may be moved to a lower position where, for example, the substrates 240 may be loaded or unloaded. An exhaust ring 220 may be disposed around the periphery of the substrate carrier plate 212 during processing to help prevent deposition from occurring in the lower volume 210 and also help direct exhaust gases from the chamber 202 to the exhaust ports 229. The lower dome 219 may be made of transparent material, such as high-purity quartz, to allow light to pass through for radiant heating of the substrates 240. The radiant heating may be provided by a plurality of inner lamps 221A and outer lamps 221B disposed below the lower dome 219. Reflectors 266 may be used to help control exposure of the chamber 202 to the radiant energy provided by the inner lamps 221A and outer lamps 221B. Additional rings of lamps (not shown) may also be used for finer temperature control of the substrates 240.

A purge gas (e.g., a nitrogen containing gas) may delivered into the chamber 202 from the showerhead assembly 204 through one or more purge gas channels 281 coupled to a purge gas source 282. The purge gas is distributed through a plurality of orifices 284 about the periphery of the showerhead assembly 204. The plurality of orifices 284 may be configured in a circular pattern about the periphery of the showerhead assembly 204 and positioned to distribute the purge gas about the periphery of the substrate carrier plate 212. The distribution of the purge gas about the periphery of the substrate carrier plate 212 prevents undesirable deposition on edges of the substrate carrier plate 212, the showerhead assembly 204, and other components of the chamber 202 which would otherwise result in particle formation and contamination of the substrates 240. The purge gas flows downwardly into multiple exhaust ports 229, which are disposed around an annular exhaust channel 205. An exhaust conduit 211 connects the annular exhaust channel 205 to a vacuum system 213, which includes a vacuum pump 207. Additionally, purge gas tubes 283 may be disposed near the bottom of the chamber body 201. In this configuration, the purge gas enters the lower volume 210 of the chamber 202 and flows upwardly past the substrate carrier plate 212 and exhaust ring 220 and into the multiple exhaust ports 229. The pressure of the chamber 202 may be controlled using a valve system, which controls the rate at which the exhaust gases are drawn from the annular exhaust channel 205.

The chemical delivery module 203 supplies chemicals to the chamber 202. Reactive gases (e.g., first and second precursor gases), carrier gases, purge gases, and cleaning gases may be supplied from the chemical delivery system through supply lines and into the chamber 202. The gases are supplied through supply lines and into a gas mixing box where they are mixed together and delivered to the showerhead assembly 204. Generally, supply lines for each of the gases may include shut-off valves, mass flow controllers, concentration monitors, and backpressure regulators. Valve switching control may be used for quick and accurate valve switching capability. Moisture sensors in the gas lines measure water levels and can provide feedback to the system software which in turn can provide warnings/alerts to operators. The gas lines may also be heated to prevent precursors and cleaning gases from condensing in the supply lines. Depending upon the process used, some of the sources may be liquid rather than gas. When liquid sources are used, the chemical delivery module includes a liquid injection system or other appropriate mechanism (e.g., a bubbler) to vaporize the liquid. Vapor from the liquids is then usually mixed with a carrier gas.

The temperature of the walls of the chamber 202 and surrounding structures, such as the exhaust passageway, may be further controlled by circulating a heat-exchange liquid through channels (not shown) in the walls of the chamber 202. The heat-exchange liquid can be used to heat or cool the chamber body 201 depending on the desired effect. For example, hot liquid may help maintain an even thermal gradient during a thermal deposition process, whereas a cool liquid may be used to remove heat from the system during an in-situ plasma process, or to limit formation of deposition products on the walls of the chamber. This heating, referred to as heating by the “heat exchanger”, beneficially reduces or eliminates condensation of undesirable reactant products and improves the elimination of volatile products of the process gases and other contaminants.

The showerhead assembly 204 has a first processing gas channel 204A coupled with the chemical delivery module 203. The first processing channel 204A is fluidly coupled to outer gas conduit 245. A blocker plate 255 having a plurality of orifices 257 disposed therethrough is positioned across the first processing gas channel 204A. A first precursor or first process gas mixture is delivered from the chemical delivery module 203 to the processing region 218 via a first processing gas inlet 259. In one embodiment, the chemical delivery module 203 is configured to deliver a metal organic precursor to the first processing gas channel 204A. For example, the metal organic precursor may comprise a suitable gallium (Ga) precursor (e.g., trimethyl gallium (“TMG”), triethyl gallium (TEG)), a suitable aluminum precursor (e.g., trimethyl aluminum (“TMA”)), or a suitable indium precursor (e.g., trimethyl indium (“TMI”)).

The showerhead assembly 204 also has a second processing gas channel 204B coupled with the chemical delivery module 203. A second precursor or second process gas mixture is delivered to the processing region 218 via a second processing gas inlet 258. The chemical delivery module 203 may be configured to deliver a suitable nitrogen containing processing gas, such as ammonia (NH₃) or other MOCVD or HVPE processing gas, to the second processing gas channel 204B. A first horizontal wall 276 of the showerhead assembly 204 separates the second processing gas channel 204B from the first processing gas channel 204A.

During processing, a first precursor gas flows from the first processing gas channel 204A and a second precursor gas flows from the second processing gas channel 204B towards the surface of the substrates 240. The first precursor gas and/or second precursor gas may comprise one or more precursor gases or process gasses as well as carrier gases and dopant gases. The draw of the exhaust ports 229 may affect gas flow so that the process gases flow substantially tangential to the substrates 240 and may be uniformly distributed radially across the substrate deposition surfaces in a laminar flow. Generally, the processing region 218 is maintained at a pressure of about 80 Torr to about 760 Torr during a deposition process.

The showerhead assembly 204 may further include a temperature control channel 204C coupled with a heat exchanging system 270 for flowing a heat exchanging fluid through the showerhead assembly 204. The heat exchanging system 270 is adapted to regulate the temperature of the showerhead assembly 204. Suitable heat exchanging fluids include, but are not limited to, water, water-based ethylene glycol mixtures, a perfluoropolyether (e.g., GALDEN® fluid), oil-based thermal transfer fluids, or similar fluids. A second horizontal wall 277 of the showerhead assembly 204 separates the second processing gas channel 204B from the temperature control channel 204C. The temperature control channel 204C may be separated from the processing region 218 by a third horizontal wall 278 of the showerhead assembly 204.

The showerhead assembly 204 also includes a first metrology assembly 291 attached to a first metrology port 296, and a second metrology assembly 292 attached to a second metrology port 297. The first metrology port 296 and the second metrology port 297 each include a metrology conduit 298 that is positioned in an aperture formed through the showerhead assembly 204. The metrology conduit 298 may be attached to the showerhead assembly 204, for example by brazing, such that each of the channels 204A, 204B, and 204C are separated and sealed from one another. The first metrology assembly 291 and the second metrology assembly 292 are used to monitor the processes performed on the surface of the substrates 240 disposed in the processing region 218 of the chamber 202.

The first metrology assembly 291 may include a temperature measurement device such as an optical pyrometer. The second metrology assembly 292 may include an optical measurement device, such as an optical stress, or substrate bow, measurement device.

The first metrology assembly 291 and the second metrology assembly 292 include a first gas assembly 291A and a second gas assembly 292A, respectively. The first gas assembly 291A and a second gas assembly 292A are adapted to deliver a gas from the chemical delivery module 203 through the metrology conduits 298 and into the processing region 218 of the chamber 202. The chemical delivery module 203 may also provide a purge gas to the first gas assembly 291A and second gas assembly 292A so as to prevent deposition of material on the surface of components within the assemblies. Additionally or alternatively, the chemical delivery module 203 may provide a cleaning gas, such as a halogen containing gas, to the first gas assembly 291A and the second gas assembly 292A both to clean the surface of components within the assemblies and to deliver the cleaning gas directly into the processing region 218.

The showerhead assembly 204 also includes one or more cleaning gas conduits 204D coupled with the chemical delivery module 203. A cleaning gas is delivered form the chemical delivery module 203 to the processing region 218 via a cleaning gas inlet 260. This allows for the cleaning gas to be delivered directly through the showerhead assembly 204 and into the processing region 218 without being distributed through the first gas channel 204A or the second gas channel 204B. The cleaning gas provided to the processing region 218 may comprise a halogen containing gas. The cleaning gas provided to the processing region 218 may comprise fluorine (F₂) gas, chlorine (Cl₂) gas, bromine (Br₂) gas, iodine (I₂) gas, hydrogen iodide (HI), iodine chloride (ICl), methyl chloride (CH₃Cl), hydrogen chloride (HCl), hydrogen bromide (HBr), hydrogen fluoride (HF), nitrogen trifluoride (NF₃), and/or other similar gases. After entering the processing region 218, the cleaning gas is distributed thereabout to remove deposits from chamber components, such as the substrate support 214, the surface of the showerhead assembly 204, and the walls of the chamber body 201. The cleaning gas is then removed from the chamber 202 via exhaust ports 229 which are disposed about an annular exhaust channel 205 disposed within walls of the chamber body 201. Additionally, a remote plasma source 226 may be provided to generate plasma from the cleaning gas received from the chemical delivery module 203. The plasma or ionized gas may then be flown in to the processing region 218 to clean one or more chamber components.

Chamber cleaning generally occurs prior to or subsequent to a deposition process while substrates 240 are absent from the chamber 202. However, cleaning gas may also be introduced to the processing region 218 when substrates 240 are present in the chamber 202. For example, a cleaning gas may be provided to the processing region 218 to clean a surface of substrates 240. The cleaning gas may be used to remove contaminants, such as native oxides, from the surface of substrates 240. The cleaning gas may be delivered into chamber 202 from the chemical delivery module 203 through the cleaning gas inlet 260 and into the processing region 218. The cleaning gas can then contact substrates 240 to remove contaminants therefrom. The cleaning gas can be removed from the processing region by vacuum system 213, and a material may subsequently be deposited on the surface of substrates 240. During the deposition process, a first precursor gas may flow from the first processing gas channel 204A and a second precursor gas may flow from the second processing gas channel 204B towards the surface of the substrates 240. Since the cleaning gas, the first precursor gas, and the second precursor gas are delivered into the processing region 218 through separate channels, contamination during subsequent processes is reduced or minimized. Additionally, both cleaning and deposition can occur in the same chamber while reducing contamination and increasing process throughput.

As shown in FIG. 2B, a cleaning plate 230 may be positioned on the substrate support 214 during the cleaning process. The cleaning plate 230 is generally formed from an optically transparent material, such as quartz or sapphire, to allow light from inner lamps 221A and outer lamps 221B to pass therethrough and heat components in the chamber, for example, the showerhead assembly 204. The substrate support 214 may also be formed from an optically transparent material to allow light to pass therethrough. In another embodiment, the substrate support 214 may be formed in a spoked-wheel configuration such that material is absent or missing from between the spokes to allow light to pass therethrough. When the substrate support 214 is formed as a spoked-wheel, the substrate support 214 need not be constructed from an optically transparent material. A carrier plate or cleaning plate 230 can be supported by the spokes, or may be supported by a ring 214A, or lip, located along the outer edge of the substrate support 214.

After one or more deposition processes, the chamber 202 may require cleaning. In certain embodiments, if a carrier plate 212 (FIG. 2B) is present on the substrate support 214 at that time, the carrier plate 212 may be removed from the chamber 202 and replaced with cleaning plate 230 in a manner similar to loading a new carrier plate. After cleaning plate 230 is positioned on the substrate support 214, the substrate support 214 is elevated to a cleaning position in close proximity to the showerhead assembly 204, as illustrated in FIG. 2B. This elevated position creates a gap 237 between the upper wall 232 of the cleaning plate 230 and the lower surface of the showerhead assembly 204. Gap 237 may be about 1 millimeter to about 4 millimeters in size so that cleaning gas may be restricted between a lower surface of the showerhead assembly 204 and the upper surface 236 of the cleaning plate 230 by the upper wall 232. With the substrate support 214 and the cleaning plate 230 located in elevated cleaning position, a cleaning gas is provided to the processing region 218. The substrate support 214 and the cleaning plate 230 may be rotated so that turbulence-inducing structures 234 create a convective movement within the cleaning gas to clean the lower surface of the showerhead assembly 204.

Periodically, it is desirable to clean the components of the processing chamber between deposition processes. To clean components of the processing chamber, cleaning gas may be delivered from the chemical delivery module through the first processing gas channel 204A or the second processing gas channel 204B. Preferably, the cleaning gas is directly provided to the processing region 218 via the one or more cleaning gas inlets 260 and cleaning gas conduits 204D. Each cleaning gas conduit 204D may be a cylindrical tube located within aligned holes disposed through a top horizontal wall 279, the first horizontal wall 276, the second horizontal wall 277, and the third horizontal wall 278 of the showerhead assembly 204. Each cleaning gas conduit 204D may be attached to the first horizontal wall 276, the second horizontal wall 277, and the third horizontal wall 278 of the showerhead assembly 204 by any suitable means, such as brazing. Preferably, the cleaning gas conduit 204D is attached such that each of the channels 204A, 204B, and 204C of the showerhead assembly 204 are separated and isolated from one another.

The cleaning gas may also be distributed through the first gas channel 204A and/or second gas channel 204B through their respective gas inlets. The cleaning gas may then be routed through inner gas conduits 246 and/or outer gas conduits 245, respectively, and into the processing region 218.

For example, a cleaning gas may be delivered through the cleaning gas conduit 204D, and/or the metrology conduits to directly clean an empty carrier plate (not shown) disposed in the processing region 218, or to clean a substrate (not shown) prior to deposition. By delivering the cleaning gas directly through the showerhead assembly 204 and by-passing the first and second gas channels 204A and 204B, the components of the processing chamber are efficiently cleaned while reducing scavenging. Processing chamber components may be cleaned as needed or after a predetermined number of deposition cycles or processes. The frequency and/or duration of each cleaning may be determined based on the thickness of each layer deposited or the material deposited.

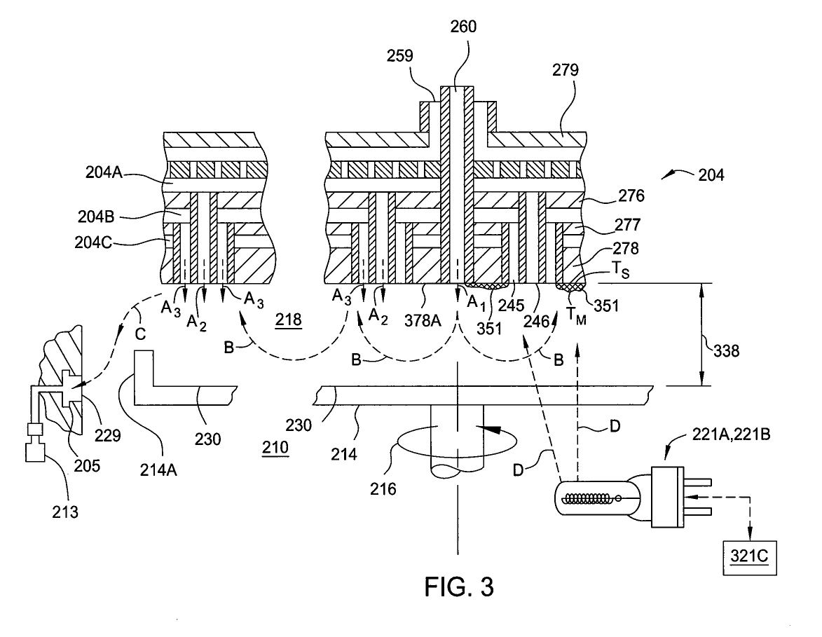

FIG. 3 is an enlarged schematic cross-sectional view of a showerhead assembly and substrate support. The substrate support 214 is shown in an elevated cleaning position in close proximity to the showerhead assembly 204. A cleaning plate similar to cleaning plate 230 (FIG. 2B) may be positioned on the substrate support 214 during the cleaning processes described herein. The substrate support 214 and the showerhead surface 378A of the showerhead assembly 204 are separated by a distance 338 small enough to maintain turbulent flow of a cleaning gas in processing region 218 between the substrate support 214 and surface 378A of the showerhead assembly 204. In one embodiment, the substrate support 214 and the showerhead surface 378A are separated by distance 338, which can be within a range from about 5 millimeters to about 15 millimeters. In one embodiment, the distance 338 is about 10 millimeters.

As discussed above, the showerhead assembly 204 may include a temperature control channel 204C to maintain the temperature of the showerhead assembly 204 at a temperature Tₛ. During a cleaning process, temperature Tₛ is generally within a range from about 50° C. to about 200° C.

Inner lamps 221A and outer lamps 221B are positioned adjacent to a component to be cleaned and are coupled to a power source 321C. Inner lamps 221A and outer lamps 221B are adapted to provide light D to surface 378A through the substrate support 214. In the embodiment of FIG. 3, power source 321C is adapted to provide about 20 kilowatts of energy to the inner lamps 221A and the outer lamps 221B. In another embodiment, power source 321C may be adapted to provide about 60 kilowatts to about 70 kilowatts of energy if necessary to heat deposited material 351 to temperature Tₘ. Preferably, temperature Tₘ is sufficiently high to cause sublimation or vaporization of deposited material 351 after deposited material 351 has been contacted with a cleaning gas. The deposited material 351 is a material which accumulates on the showerhead surface during a deposition process, such as an MOCVD process. For example, deposited material 351 may be indium gallium nitride, p-doped or n-doped gallium nitride, aluminum nitride, aluminum gallium nitride, or combinations thereof. The amount of power applied by power source 321C depends upon the composition of the deposited material 351, the pressure of the chamber, the cleaning gas to be applied, and the temperature of the chamber components, among other factors.

The substrate support 214 and the cleaning plate 230 may be formed from an optically transparent material to allow light D from lamps 221A and 221B to reach the deposited material 251.

During a typical cleaning process, a cleaning gas is delivered to the processing region 218 through the cleaning gas inlet 260. The cleaning gas travels downward from the showerhead assembly 204 toward the substrate support 214 and quickly flows out the annular exhaust channel 205. The short residence time of the cleaning gas within the processing region 218 leads to inefficient removal of deposited material, for example, deposited material 351 from the surface 378A of the showerhead assembly 204.

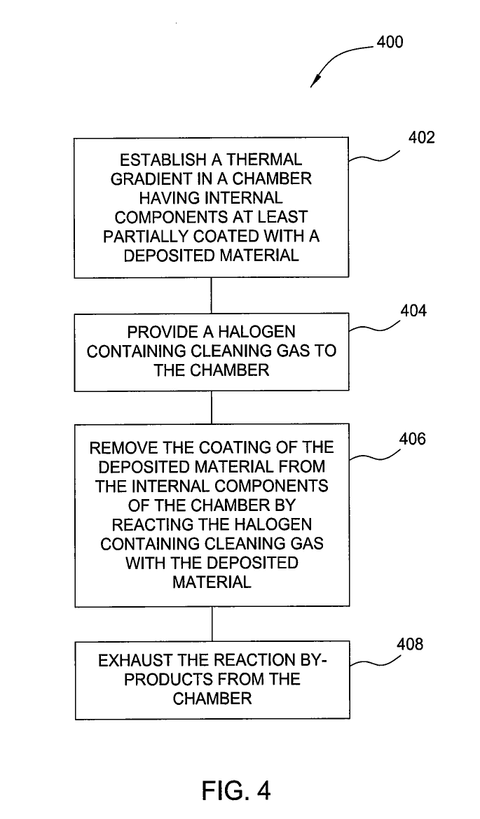

FIG. 4 is a flow diagram summarizing a method 400 for removing unwanted deposits from internal surfaces of a chamber according to one embodiment. As shown in block 402, a thermal gradient is established in a chamber having internal components at least partially coated with a deposition product. The thermal gradient may be established in the processing region 218 during the cleaning process leading to a buoyancy effect within the processing region 218 which creates convection rolls. The convection rolls may be used to direct the cleaning gas toward a particular component or region of the processing chamber for cleaning.

The thermal gradient may be established prior to or during the introduction of cleaning gas into the processing region 218 or prior to and during the introduction of cleaning gas into the processing region 218. The thermal gradient may be a vertical thermal gradient established by creating a temperature differential between the showerhead assembly 204 and the substrate support 214. The vertical temperature gradient may direct the cleaning gas back toward the surface 378A of the showerhead assembly 204 to remove deposited material 351. The substrate support 214 may have a higher temperature relative to the temperature of the showerhead assembly 204. In certain embodiments, the showerhead assembly 204 may have a temperature between about 50° C. and 550° C. All individual values and sub-ranges from 50° C. and 550° C. are included herein; for example, the temperature of the showerhead assembly 204 may be from a lower limit of 50° C., 100° C., 200° C., 350° C., or 450° C. to, independently, an upper limit of 100° C., 200° C., 350° C., 450° C., or 550° C. In certain embodiments, the showerhead assembly 204 may have a temperature between about 50° C. and 200° C. In certain embodiments, the substrate support 214 may have a temperature between about 400° C. and 1,000° C. All individual values and sub-ranges from 400° C. and 1,000° C. are included herein; for example, the temperature of the substrate support 214 may be from a lower limit of 400° C., 550° C., 600° C., 700° C., 800° C., 900° C., or 1,000° C., independently, an upper limit of 600° C., 700° C., 800° C., 900° C., 1,000° C., or 1,150° C. In certain embodiments, the temperature of the chamber walls may be regulated during formation of the thermal gradient.

In one embodiment, the chamber pressure is between about 1 mTorr and 760 Torr. In certain embodiments, the cleaning process is performed at higher pressures, for example, between about 500 Torr and about 760 Torr. In certain embodiments, the cleaning process is performed at low pressures, for example, up to 100 Torr, 50 Torr, 5 Torr, or up to 1 Torr. In certain embodiments, the cleaning process is performed at low pressures, for example, at least 1 mTorr, 5 mTorr, 1 Torr, 5 Torr, or at least 50 Torr. In certain embodiments, the cleaning process is performed at a chamber pressure between 5 mTorr and 100 Torr.

The vertical temperature gradient within the processing region 218 may permit the cleaning gas to rise within the processing region 218 as it is heated and fall as it cools. It is believed that the raising of the cleaning gas increases the residence time of the cleaning gas at the surface 378A of the showerhead assembly 204 thus increasing the efficiency of the cleaning process.

As shown in block 404, a halogen containing gas is provided into the processing chamber. The halogen containing gas may be introduced prior to, subsequent to or during the formation of the thermal gradient. The cleaning gas may be delivered to the processing region 218 through the cleaning gas inlet 260 along flow paths A1, or through processing gas inlet 259 to the inner gas conduits 246 along flow paths A2. Additionally or alternatively, a cleaning gas may be introduced to the processing region 218 through the outer gas conduits 245 along flow paths A3.

The thermal gradient causes a turbulent or convective flow of the cleaning gas as denoted by turbulence lines B. The cleaning gas enters the processing region 218 as described above and directed back towards the showerhead surface 378A as shown by turbulence lines B. The turbulence along lines B increases the amount of contact between the cleaning gas and the deposited material 351 on the showerhead surface 378A. In addition, the turbulence along lines B induces mixing of the cleaning gas within the processing region 218 to reduce the concentration gradient of the cleaning gas. When the concentration gradient is reduced (e.g., the cleaning gas has a more uniform concentration in the processing region 218), the reaction rate between the cleaning gas and the deposited material is increased because fresh cleaning gas is constantly being circulated to the showerhead surface 378A. Without the convective mixing provided by the thermal gradient the reaction between the deposited material 351 and the cleaning gas would proceed at a slower rate, thus increasing the amount of time required to clean the chamber components and the showerhead surface 378A.

Although discussed as a vertical thermal gradient formed between the showerhead assembly 204 and the substrate support 214 it should also be understood that thermal gradients of other directional orientations may be used with the cleaning processes described herein when it is desirable to concentrate cleaning gas in other areas of the chamber 106. For example, the thermal gradient may be a lateral thermal gradient. A lateral thermal gradient may be used when it is desirable to remove deposits from portions of the chamber such as the chamber walls. The lateral gradient may be formed by using the lamps 221A and 221B to create different temperature zones within the chamber. In embodiments where the cleaning plate 230 is used, the lamps 221A and 221B may be used to create different temperature zones along across the cleaning plate 230. In certain embodiments, different temperature zones may be created across the substrate support 214 by heating the substrate support 214.

At block 406, the coating of deposited material is removed from the internal components of the processing chamber by reacting the halogen containing gas with the deposited material. At block 408, the reaction by-products are exhausted from the processing chamber.

The cleaning process may be performed using both the thermal gradient and the cleaning plate to further increase the efficiency of the cleaning process. With cleaning gas present in processing region 218 and the thermal gradient established, the substrate support 214 and the cleaning plate 230 are rotated as indicated by arrow 216. Generally, the substrate support 214 and the cleaning plate 230 are rotated at a rate of about 20 revolutions per minute to about 100 revolutions per minute, for example, about 60 revolutions per minute or about 80 revolutions per minute. The substrate support 214 may have a ring 214A located along the outer edge of the substrate support 214 defining a recessed bottom and a raised sidewall, allowing the carrier plate 212 or cleaning plate 230 to set down on the lip while being supported by the sidewall.

In certain embodiments, the cleaning plate 230 and/or the substrate support 214 may be heated during the cleaning process. The cleaning plate 230 and/or the substrate support 214 may have a temperature between about 400° C. and 1,000° C. All individual values and sub-ranges from 400° C. and 1,000° C. are included herein; for example, the temperature of the cleaning plate 230 and/or the substrate support 214 may be from a lower limit of 400° C., 550° C., 600° C., 700° C., 800° C., 900° C., or 1,000° C., independently, an upper limit of 600° C., 700° C., 800° C., 900° C., 1,000° C., or 1,150° C.

In embodiments, where the cleaning plate 230 is used, the upper wall 232 of the cleaning plate 230 forms a gap 237 with the showerhead surface 378A (See FIG. 2B). The gap 237 is maintained at a distance such that a minimal amount of cleaning gas passes therethrough during the cleaning process, however, the gap is large enough to prevent contact between the upper wall 232 and showerhead surface 378A.

The effect of a cleaning gas in the processing region 218 depends upon multiple factors, including but not limited to the temperature and pressure of the cleaning gas, the type of cleaning gas used, the temperature of the deposited material 351, the pressure within the processing region 218, and the amount of deposited material 351 present. Preferably, process parameters such as temperature and pressure within the chamber and of the cleaning gas, and the composition of the cleaning gas are adjusted to cause the deposited material 351 to react with the cleaning gas to form a volatile component that will be vaporized. Generally, the vaporization point of the deposited material 351 is known, therefore, the process parameters can be adjusted or selected to cause vaporization of the deposited material 351. Vaporization and removal of the deposited material 351 can be effected by contacting the deposited material 351 with a cleaning gas, increasing the temperature of the deposited material 351 with lamps 221A and 221B, and/or reducing the pressure of the processing region 218 with vacuum system 213.

It should also be noted that the pressure within the processing region 218 and the density of the cleaning gas also affect the removal rate of the deposited material 351. While lowering the pressure within the processing region 218 lowers the vaporization temperature of the deposited material 351, it also reduces the pressure of the cleaning gas present in the processing region and changes the flow characteristics of the cleaning gas. The reduced pressure within the processing region 218 decreases the density of the cleaning gas present, which can change the flow of the cleaning gas from a viscous flow state to a molecular flow state, and affect the cleaning gas interaction with the deposited material 351. This transition not only depends upon pressure, but also upon temperature and the composition of the cleaning gas. The lower the density of the cleaning gas, the lower the amount of cleaning gas per unit volume that can contact the deposited material 351.

In one embodiment, the cleaning gas may be chlorine gas and the deposited material may be a gallium-containing material such as indium gallium nitride, gallium nitride, or the aluminum gallium nitride. The cleaning gas may be introduced to the processing region 218 at a concentration within a range from about 5 percent to about 50 percent, for example, about 30 percent. The remainder of the gas provided to the chamber may be an inert gas, such as argon. Using vacuum system 213, the pressure within the chamber can be reduced to a range within about 1×10⁻⁶ Torr to about 200 Torr, such as about 5 Torr to about 200 Torr. Preferably, the pressure is about 50 Torr. Power is applied to the inner lamps 221A and outer lamps 221B to heat the deposited material 351 with light D. The amount of power applied to the inner lamps 221A and outer lamps 221B depends on the size of the showerhead assembly 204. A thermal gradient is established in the processing region 218. The deposited material 351 is heated with the lamps to temperature Tₘ which is about 700° C., and the substrate support is maintained at temperature Tₛ, which is about 100° C. The wavelengths of light delivered from the lamps 221A, 221B may be adjusted to enhance the cleaning process. In one embodiment, the cleaning process may be photo-enhanced. In one example, the delivered wavelengths of light are in the ultraviolet (UV) (e.g. 10 nm to 400 nm) or infrared (IR) spectrums of light. In another example, a broadband light source is used to deliver many different wavelengths of light.

Cleaning gas is introduced to the processing region 218, and the thermal gradient causes turbulence along lines B. The turbulence along lines B induces contact between the cleaning gas and the deposited material 351 which react to form GaCl or GaCl₃. The GaCl and/or GaCl₃ are vaporized at temperature Tₘ and removed from the showerhead surface 378A. After a sufficient amount of deposited material 351 is vaporized, the substrate support 214 is lowered, increasing the distance 338 between the showerhead assembly 204 and the substrate support 214. With the distance 338 increased, the cleaning gas and vaporized material can escape the processing region 218, and are removed from the chamber along flow path C through the exhaust ports 229 and annular exhaust channel 205. The carrier plate may then be re-inserted into the processing chamber for further processing.

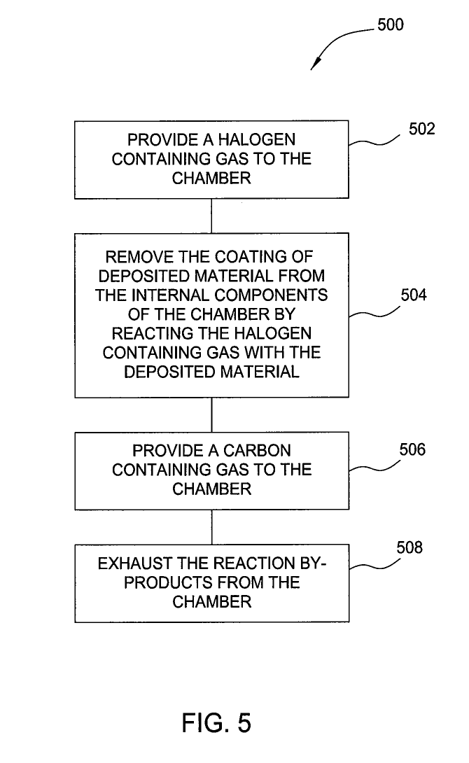

FIG. 5 is a flow diagram summarizing another method 500 for removing unwanted deposits from internal surfaces of a chamber according to one embodiment. In certain embodiments, it may be desirable to flow a carbon containing gas into the processing region 218 during the cleaning process. It is believed that the addition of a carbon containing gas during the cleaning process will form compounds with a higher saturation vapor pressure which will facilitate the sublimation process. At block 502, a halogen containing cleaning gas is provided to the chamber. At block 504, the coating of deposited material from the internal components of the chamber is removed by reaction of the halogen containing cleaning gas with the deposited material. At block 506, a carbon containing gas is provided to the chamber. The carbon containing gas may be any alkyl containing gas. The carbon containing gas may be a trialkyl Group III compound having the chemical formula of R″R′RM, where M is gallium, aluminum, or indium, and each R″, R′, and R is independently selected from methyl, ethyl, propyl, butyl, isomers thereof, derivatives thereof, or combinations thereof. The carbon containing gas may be selected from the group of trialkyl gallium, trialkyl aluminum, trialkyl indium, and combinations thereof wherein the alkyl group may be selected from methyl, ethyl, propyl, butyl, isomers thereof, derivatives thereof, or combinations thereof. The carbon containing gas may be a metal organic precursor selected from the group of trimethyl gallium (“TMG”), triethyl gallium (TEG), trimethyl aluminum (“TMA”), and trimethyl indium (“TMI”).

In certain embodiments, the cleaning gas may be flowed into the processing region to form a cleaning gas/deposited material compound and the carbon containing gas may be flowed into the processing region after the cleaning gas to form a carbon containing gas/deposited material compound. In certain embodiments, the cleaning gas and the carbon containing gas may be simultaneously flowed into the processing region 218.

For example, in one embodiment where the cleaning gas is chlorine and the deposited material is gallium, chlorine gas is flowed into the processing region 218 to react with the deposited material forming GaCl₃ and/or GaCl₂. Since both GaCl₃ and/or GaCl₂ have a low vapor pressure, during certain cleaning process it is difficult to sublime GaCl₃ and/or GaCl₂ at the temperature of the showerhead assembly 204. The carbon containing gas is flowed into the processing region to react with gallium to form an alkyl gallium compound, e.g., TMG, which has a high saturation vapor pressure and will easily sublimate and can be removed from the processing chamber. In one embodiment where the carbon containing gas is TMA, the methyl groups react with gallium to form TMG and aluminum reacts with chlorine to form AlCl₃ both of which are then removed from the processing chamber.

In one embodiment where the cleaning gas is chlorine and the deposited material is indium, chlorine gas is flowed into the processing region 218 to react with the deposited material forming InCl₃ and/or InCl₂. Since both InCl₃ and/or InCl₂ have a low vapor pressure, during certain cleaning process it is difficult to sublime InCl₃ and/or InCl₂ at the temperature of the showerhead assembly 204. The carbon containing gas is flowed into the processing region to react with indium to form an alkyl indium compound, e.g., TMI, which has a high saturation vapor pressure and will easily sublimate and can be removed from the processing chamber.

In one embodiment where the cleaning gas is an iodine containing gas and the deposited material is indium, iodine gas is flowed into the processing region 218 to react with the deposited material forming InI₃ and/or InI₂. Since both InI₃ and/or InI₂ have a high vapor pressure, it is easy to sublimate InI₃ and/or InI₂ at the temperature of the showerhead assembly 204. A carbon containing gas may be flowed into the processing region to react with indium to increase the rate of reaction.

At block 508, the reaction by-products are exhausted from the chamber.

In certain embodiments, deposited material may be removed from the showerhead assembly by increasing the flow velocity of the cleaning gas through the injection conduit. It is believed that increasing the flow rate of the cleaning gas into the processing region will remove deposited material from the showerhead assembly. In one embodiment, the increased flow rate of the cleaning gas may be achieved by mixing the cleaning gas with a carrier gas. In one embodiment, the flow rate of the cleaning gas and carrier gas is similar to the flow rate of precursors used during a deposition process. For example, when the precursor flow rate during a deposition process is 60 slm and the flow rate of cleaning gas is 4 slm, carrier gas may be added to the cleaning gas to achieve a total cleaning gas/carrier gas flow rate of about 60 slm. Thus the total flow rate of the cleaning gas/carrier gas is high but the cleaning gas concentration remains the same. In one embodiment, the flow rate of the cleaning gas may be increased by a factor of 5, 10, 15, or 20 or more. The increase in flow rate may be achieved by increasing the flow rate of the cleaning gas itself or combining the cleaning gas with a carrier gas to achieve the increased flow rate as described above. For example, if the flow rate of cleaning gas is typically 2 to 4 meters/second the flow rate of cleaning gas may be increase to between about 20 meters/second to about 40 meters/second.

In certain embodiments, after the cleaning process, a deposition resistant film may be applied to the chamber components. A scavenging gas for removing residual halogen gas may be flowed into the chamber. Examples of gases that may scavenge residual halogen from chamber surfaces are nitrogen containing gases, such as ammonia (NH₃), nitrogen gas (N₂), or hydrazine (H₂N₂), and hydrogen containing gases, such as simple hydrocarbons methane (CH₄), ethane (C₂H₆), ethylene (C₂H₄), and acetylene (C₂H₂), or other hydrides, such as silane (SiH₄), disilane (Si₂H₆), or germane (GeH₄). A metal or silicon containing gas may be added to the scavenging gas from 310 to deposit a film on internal surfaces of the chamber. Metal gases include the metal organic precursors previously described herein. The deposition resistant film such as silicon carbide (SiC), silicon nitride (SiN), gallium nitride (GaN), aluminum nitride (AlN), or films composed of more than one such component, may be more resistant to deposition in an MOCVD process than the clean chamber surfaces themselves.

While the foregoing is directed to embodiments of the present invention, other and further embodiments of the invention may be devised without departing from the basic scope thereof, and the scope thereof is determined by the claims that follow.

We claim:

1. A method of cleaning a showerhead assembly, comprising:
establishing a thermal gradient in a processing region of a chamber having a showerhead assembly with deposited material thereon;
providing a halogen containing cleaning gas to the processing region, wherein the thermal gradient causes a turbulent or convective flow of the cleaning gas;
removing the deposited material from the showerhead assembly; and
exhausting reaction by-products from the processing region.

2. The method of claim 1, wherein the thermal gradient is formed by creating a temperature differential between the showerhead assembly and a substrate support positioned below the showerhead assembly.

3. The method of claim 2, wherein creating a temperature differential comprises heating the substrate support to a temperature greater than a temperature of the showerhead assembly.

4. The method of claim 3, wherein heating the substrate support comprises lamp heating the substrate support.

5. The method of claim 1, wherein the turbulent or convective flow directs the cleaning gas toward the showerhead assembly to increase a residence time of the cleaning gas at a surface of the showerhead assembly.

6. The method of claim 1, wherein providing a halogen containing cleaning gas to the processing region occurs subsequent to, prior to, or during establishing a thermal gradient.

7. The method of claim 1, wherein removing the deposited material from the showerhead assembly comprises vaporizing the deposited material from the showerhead assembly.

8. The method of claim 1, further comprising:
providing a carbon containing gas to the processing region after providing a halogen containing cleaning gas to the processing region.

9. The method of claim 1, further comprising:
simultaneously providing a carbon containing gas to the processing region while providing a halogen containing cleaning gas to the processing region.

10. The method of claim 1, wherein the halogen containing cleaning gas is selected from the group comprising: fluorine (F₂), chlorine (Cl₂), bromine (Br₂), iodine (I₂), hydrogen iodide (HI), iodine chloride (ICl), methyl chloride (CH₃Cl), hydrogen chloride (HCl), hydrogen bromide (HBr), hydrogen fluoride (HF), nitrogen trifluoride (NF₃), and combinations thereof.

11. The method of claim 10, wherein the deposited material is selected from the group comprising: indium gallium nitride, p-doped or n-doped gallium nitride, aluminum nitride, aluminum gallium nitride, and combinations thereof.

12. The method of claim 3, wherein the turbulent or convective flow is created in a process region between the showerhead assembly and the substrate support.

13. The method of claim 8, wherein the carbon containing gas is a metal organic precursor selected from the group of trimethyl gallium (“TMG”), triethyl gallium (TEG), trimethyl aluminum (“TMA”), and trimethyl indium (“TMI”).

14. A method of removing deposited material from one or more interior surfaces of a processing chamber, comprising:
establishing a thermal gradient in a processing region of a chamber, wherein the processing region is defined by a showerhead assembly with deposited material thereon and an opposing substrate support having a cleaning plate positioned thereon;
providing a halogen containing cleaning gas to the processing region, wherein the thermal gradient causes a turbulent or convective flow of the cleaning gas;
removing deposited material from the showerhead assembly; and
exhausting reaction by-products from the processing region.

15. The method of claim 14, wherein the thermal gradient is formed by creating a temperature differential between the showerhead assembly and the cleaning plate.

16. The method of claim 15, wherein the creating a temperature differential comprises lamp heating the cleaning plate to a temperature between 400° C. and 1,000° C. and heating the showerhead assembly to a temperature between 50° C. and 200° C.

17. The method of claim 16, further comprising rotating the substrate support and the cleaning plate.

18. The method of claim 17, wherein the deposited material is a gallium containing material and the cleaning gas is a chlorine-containing gas.

19. The method of claim 15, further comprising providing a carbon containing gas to the processing region while providing a halogen containing cleaning gas to the processing region.

20. The method of claim 19, wherein the carbon containing gas is a metal organic precursor selected from the group of trimethyl gallium (“TMG”), triethyl gallium (TEG), trimethyl aluminum (“TMA”), and trimethyl indium (“TMI”).
